(19) United States
(12) Patent Application Publication
(10) Pub. No.: US 2016/0150041 A1
(43) Pub. Date: May 26, 2016

(54) METHOD, SYSTEM, AND PROGRAM STORAGE DEVICE FOR UNIFIED CONTENT STORAGE IN SESSION-BASED SERVICES

(71) Applicant: General Electric Company, Schenectady, NY (US)

(72) Inventor: Joseph William Bolinger, Dublin, CA (US)

(21) Appl. No.: 14/549,313

(22) Filed: Nov. 20, 2014

(51) Int. Cl. H04L 29/08; G06N 99/00; H04L 29/06

(52) U.S. Cl. CPC H04L 67/2804; H04L 67/42; H04L 67/10; H04L 67/14; G06N 99/005

(57) ABSTRACT

At a session context proxy component, a first communication destined for a first session manager is intercepted. It may be identified that the first communication references a first piece of content. A request may be sent to a content access monitor to obtain metadata about the first piece of content. The metadata about the first piece of content is then sent to the first session manager for storage with session information for the first communication. A second communication destined for a second session manager is intercepted, the second communication in a different communications modality than the first communication. It may be identified that the second communication references a second piece of content. A request may be sent to the content access monitor to obtain metadata about the second piece of content. The metadata about the second piece of content is then sent to the second session manager for storage with session information for the second communication.

### TECHNICAL FIELD

This application relates generally to session-based services. More particularly, this application relates to unified content storage in session-based services.

### BACKGROUND

During software-mediated collaboration sessions, such as live video conferencing and screen sharing, users often refer to, or share content items, such as documents, images, videos, etc. with each other. This extends to other forms of communication as well, such as cellular phone conversations, text messages, email, etc. Often the content items may be shared via a different communication channel than that by which the conversation is taking place. For example, users may be collaborating via live video conference and one of the users may email a document to the other users for discussion during the live video conference. In other instances, a content item may be discussed but not actually shared during the conversation; for example, the users in a phone call may discuss a document that they both are aware of, but that is not actually exchanged during the call.

These types of circumstances make it difficult to monitor the state of the underlying conversation that users are engaging in through the system.

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating a system, in accordance with an example embodiment.

FIG. 2 is a block diagram illustrating a system, in accordance with an example embodiment, for dynamically correlating content items with session-related metadata.

FIG. 3 is a diagram illustrating the storage of a conversation in a conversation data store, in accordance with an example embodiment.

FIG. 4 is a flow diagram illustrating a method, in accordance with an example embodiment.

FIG. 5 is a sequence diagram illustrating a method, in accordance with an example embodiment.

FIG. 6 is a block diagram illustrating a mobile device, according to an example embodiment.

FIG. 7 is a block diagram of a machine in the example form of a computer system within which instructions may be executed to cause the machine to perform any one or more of the methodologies discussed herein.

### DETAILED DESCRIPTION

### Overview

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, a reusable software architecture is provided that dynamically correlates content items with session-related metadata, even across multiple communications channels. The content items, such as documents, images, and video, may be held in external systems that are not managed by the same entity that manages session-based services. A proxy component may be used to intercept all incoming requests from clients. The proxy component may delegate requests to a set of sub-systems, which may comprise session providers such as video conferencing servers, instant messaging servers, etc., and a set of content management systems, which may manage content repositories storing various types of media. The technical effect is that a reusable architecture is provided for federating real-time, session-based, collaborative systems with content sources in order to generate additional metadata. This additional metadata can be used to improve the overall user experience that the client perceives without the need for costly low-level system integration.

In an example embodiment, the proxy component examines each incoming request and determines if it references a piece of content. The request may be an explicit request for content, such as a request to share a piece of content with other users (e.g., a request to attach a document to an email), or an implicit request for content, such as the mentioning of a piece of content in a conversation. The proxy component is then able to forward the request to the appropriate sub-system via a content access monitor, which accesses the content on the client's behalf and notifies session managers that a piece of content has been accessed by the client making the request.

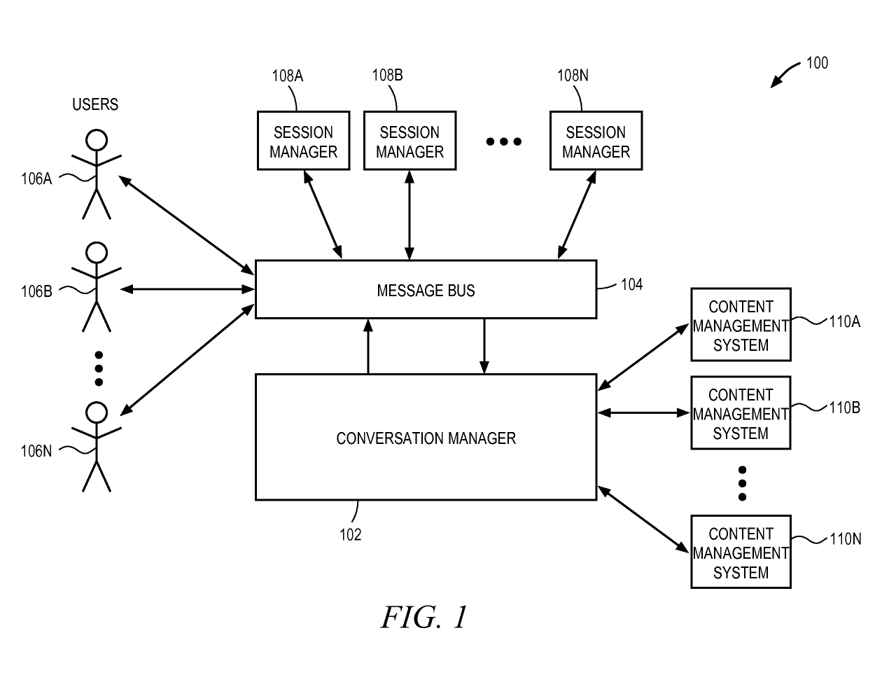

FIG. 1 is a block diagram illustrating a system 100, in accordance with an example embodiment. A conversation manager 102 may monitor conversations among users. These conversations may be intercepted by the conversation manager 102 on a message bus 104, on which one or more users 106A-106N communicate with each other via one or more session managers 108A-108N. Each of the session managers 108A-108N may correspond to a different communications modality. In some example embodiments each session manager 108A-108N may be operated by a different session entity, such as a different company hosting a session server, but in other example embodiments a different session manager 108A-108N may be used for different modalities operated by the same session entity. Examples of potentially different modalities might include video conferencing, cellular voice communication, landline communication, email, text messaging, etc. Examples of session managers 108A-108N may include, for example, a communication session manager, a messaging and presence session manger, and a collaborative annotation session manager.

Content referred to or otherwise relied on during the conversations intercepted by the conversation manager 102 may be stored by one of a plurality of content management systems 110A-110N. Examples of content management systems 110A-110N include Voice over Internet Protocol (VoIP) providers, Extensible Messaging and Presence Protocol (XMPP) providers, and Software-as-a-Service (Saas) providers.

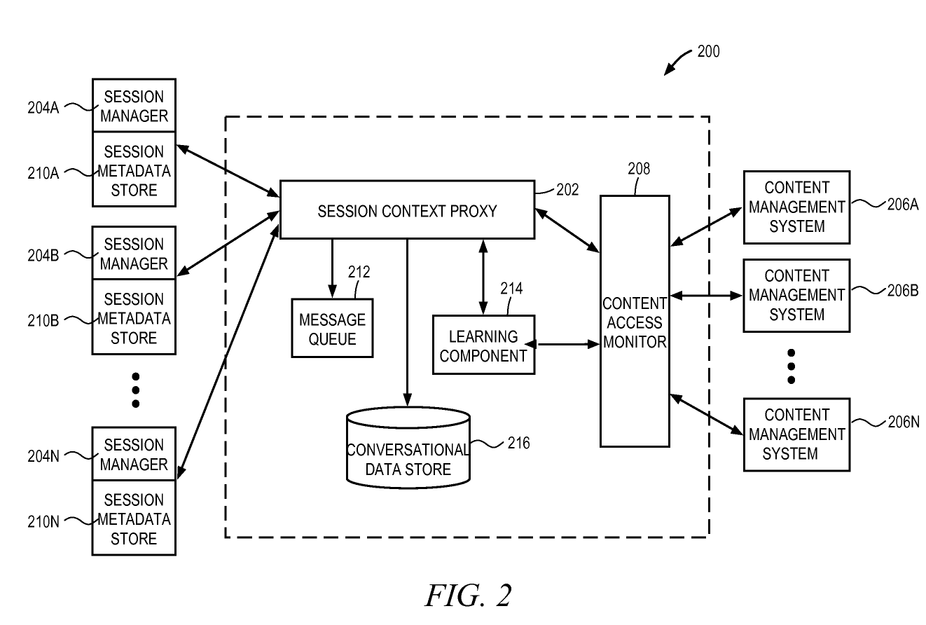

FIG. 2 is a block diagram illustrating a system 200, in accordance with an example embodiment, for dynamically correlating content items with session-related metadata. Portions of the system 200 designated by a dashed line in the figure may be located in the conversation manager 102 of FIG. 1, in some example embodiments. A session context proxy 202 intercepts requests from one or more clients. These requests may come in the form of Applicant Program Interface (API) requests. From these requests the session context proxy 202 may determine to which of a plurality of session managers 204A-204N to direct the request.

In addition to determining to which session manager 204A-204N to forward a request, the session context proxy 202 also may act to determine if the request corresponds to content stored by one of a plurality of content management systems 206A-206N. The session context proxy 202 does not need to determine which precise content management system 206A-206N is hosting the content corresponding to the request; it is only responsible for determining that there is (or at least there might be) content that corresponds to the request stored by one of the content management systems 206A-206N.

A request “corresponding” to content is intended to include any request that in some way, either explicitly or implicitly, refers to a piece of content. Examples of explicit referrals to content include communications that include attachments or specific indications of content (e.g., example locations where the content is stored, such as a Uniform Resource Locator (URL) address). Examples of implicit referrals to content include mentioning the name of a document in a voice communication or alluding to a previously shared slideshow in a video conference. As described above, a request may correspond to content even if the content is not actually contained in one of the content management systems 206A-206N. For example, a user may mention a specific document in a video conference, but it may turn out that the document is only located on the user's own hard drive. In that case, the session context proxy 202 may still determine that the request corresponds to the content and rely on a content access monitor 208 to determine that the content management systems 206A-206N do not contain this content.

If the session context proxy 202 determines that the request corresponds to content, then it may notify the content access monitor 208 of this fact. The content access monitor 208 may then act to determine which (if any) of the plurality of content management systems 206A-206N is hosting the content, and may forward the request to the appropriate content management system 206A-206N for the content to be retrieved.

In an example embodiment, the content access monitor 208 acts to obtain metadata about the content that corresponds to the request and forward that metadata to the relevant session manager 204A-204N. The session manager 204A-204N can then associate the metadata with the session. This metadata may include, for example, an identifier for the content, the time it was accessed, etc. This metadata can be stored by the session manager 204A-204N as being associated with the client's session. In another example embodiment, either in addition to or in lieu of the content metadata being stored by the session manager 204A-204N as being associated with the client's session, session metadata, possibly gathered from a session metadata store 210A-210N, can be associated with the content by the appropriate content management system 206A-206N. In other words, either the content metadata can be associated with the session or the session metadata can be associated with the content (or, in some circumstances, both).

In an example embodiment, the content access monitor 208 performs additional actions to optimize the notifications so that only relevant session managers 204A-204N are notified. For example, the content access monitor 208 may check if the client that is making the request is currently in any active session by querying each session manager 204A-204N or by checking a session cache for this information before it sends any notifications.

Additionally, each session manager 204A-204N can be individually programmed to perform additional actions according to a set of programmable policies or rules, such as notifying other users in the session that a piece of content has been accessed by another user, by, for example, injecting a notification with or without the piece of content in a message queue 212 of messages to be sent.

In an example embodiment, a learning component 214 may also be contained in the system 200. The learning component 214 may apply one or more machine-learning techniques to aid the session context proxy 202 in its determination of whether a request contains a reference to a piece of content that may be stored by one of the content management systems 206A-206N. The learning component 214 may therefore be programmed to identify references to pieces of content either explicitly or implicitly contained in communications, such as, but not necessarily limited to, requests intercepted by the session context proxy 202. In one example embodiment, natural language processors are utilized to identify references to pieces of content in speech patterns. For example, the learning component 214 may help identify that when a user speaks the phrase “Turning to the XYZ doc” during a voice communication, he or she may be referring to a specific document named “XYZ”. The learning component 214 may apply different algorithms (or different parameters for the same algorithms) for different communications modalities. For example, a user speaking the phrase “get me the graphs” during a video conference may be referring to a specific document containing graphs that is then discussed during the video conference, whereas the same phrase in an email may simply be a request for work to be performed (i.e., asking an employee to prepare graphs which haven't been prepared yet). The learning component 214 may differentiate the phrase depending on the modality in which it was mentioned.

The learning component 214 may also introduce the concept of a “conversation.” For purposes of this document, a conversation, as designated by the learning component 214 or any other component of the system 200, may be a unified stream of communications that may take place over several modalities. Thus, while others may speak of a conversation being an email communication, voice communication, or video conference communication, in an example embodiment a conversation may comprise all three, as long as they represent a single stream of communications about a particular subject or are otherwise related, such as in time or geographic distances between engaged users. Thus, for example, ten users may be conducting a video conference together, while two of them send text messages to each other during the video conference, and three others are exchanging documents via email. The learning component 214 may group all of these separate communications as a single conversation and then link the content metadata associated with all three with the conversation. This allows, for example, a user who did not participate in the video conference to easily identify which content items were discussed during the video conference, even if none of these content items were actually shared on the video conference screen or otherwise embedded into the video conference conversation.

In another example embodiment, the learning component 214 is intelligent enough to monitor communications before or after a particular conversation and add some of those communications to the conversation if relevant. For example, after the video conference above is completed, one of the users may update a spreadsheet and email it to another of the users. The learning component 214 can examine the email communicating the spreadsheet and determine whether there is an indication in the email that it is related to the ended conversation. For example, the email may say “I updated the spreadsheet as we discussed during the VC, here you go”, which may indicate that the spreadsheet is related to the completed video conference which is part of the conversation. In such a case, the learning component 214 may add this email (and metadata about the spreadsheet) to the conversation. If, alternatively, the email says “Here is a spreadsheet I think might interest you”, then the learning component 214 may not add this email (or metadata about the spreadsheet) to the conversation because it does not appear to be related to the completed video conference which is part of the conversation.

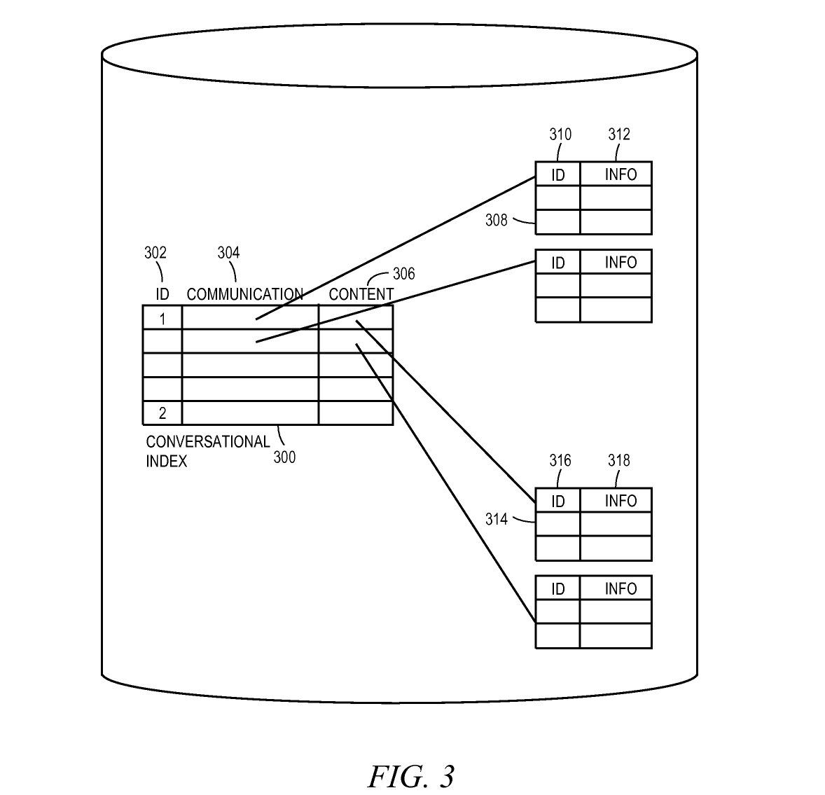

In an example embodiment, the learning component 214 and/or session context proxy 202 may act to store conversations in a conversational data store 216. This may be performed in a number of different ways. FIG. 3 is a diagram illustrating the storage of a conversation in a conversational data store in accordance with an example embodiment. In this example embodiment, a conversational index 300 may contain a record of mappings between conversation identifications 302, communications 304, and pieces of content 306. In an example embodiment, the communications 304 are actually keys to one or more communication tables 308 also stored in the conversational data store 216. Each communication table 308 may correspond to a different communication and contain a communication identification 310 and communication information 312. The communication information 312 may include, for example, a complete recording of the conversation, such as an audio file storing a recording of a phone call, a video file storing a recording of a video conference, or a text file storing a copy of an email or text communication. Likewise, in an example embodiment, the pieces of content 306 are actually keys to one or more content tables 314 also stored in the conversational data store 216. Each content table 314 may correspond to a different piece of content and contain a content identification 316 and content information 318. The content information 318 may include, for example, a complete copy of the content.

Of course, storing a complete recording of every communication and every piece of content related to a conversation in a single place may use a significant amount of storage space. As such, embodiments are foreseen where the communications themselves are not stored in the conversational data store 216, but rather the communication information 312 contains metadata about the conversation, including, for example, a pointer to where the full communication is stored. The metadata may also include information such as the time and date of the communication, which users were involved in the communication, the modality of the communication, etc.

Likewise, in an example embodiment, the pieces of content themselves are not stored in the conversational data store 216, but rather the content information 318 contains metadata about the content, including, for example, a pointer to where the full content is stored. The metadata may also include information such as the time and date of the creation or accessing of the content, which user created the content, the data type of the content, etc.

Referring back to FIG. 2, as described earlier, each session manager 204A-204N can be individually programmed to perform additional actions according to a set of programmable policies or rules, such as notifying other users in the session that a piece of content has been accessed by another user, by, for example, injecting a notification with or without the piece of content in a message queue 212 of messages to be sent. In an example embodiment, a dynamic updating component may act to dynamically update rules or policies based on information from the learning component 214 and send these updated rules or policies to the session managers 204A-204N

While the above describes a learning component 214 identifying when a communication pertains to a particular conversation, in an example embodiment this process may be simplified by examining a conversation identifier that each client application could insert into a communication. This would allow the client application to explicitly identify the communication as being related to the conversation. A similar process could be utilized to explicitly identify pieces of content as being related to the conversation.

When people collaborate to solve problems they often use a variety of systems to achieve their objective. For example, they may use video chat services to discuss a topic with their peers while referring to documents that are managed by an external content management system or some other content stored in a business application. Due to the variety of content sources available, integrating all of the software systems that people use when they collaborate is an intractable problem. In an example embodiment, as described above, metadata about what content people use when they collaborate can be valuable data that can be used to build federated systems that behave in a more seamless and integrated fashion. In an example embodiment, the software architecture for correlating content with communication channels described above allows these aspects to be accomplished without the need for post-hoc data mining. Various use cases are now presented as examples of how this solution may be utilized.

In a first example use case, employees of a company bring laptop computers on field assignments at client locations to aid clients in solving problems related to the company's products. During these field assignments, the employees may typically conduct various communications, including video conferencing, phone calls, text messages, and emails with various people at the client location. The employer, such as the employee's boss, may wish to monitor effectiveness of the employee and thus through the solution provided herein may be able to identify files accessed and utilized during the conversations on-site, in order to better gauge employee performance and/or identify areas of improvement on which to focus.

In another example use case, a first user may be giving a presentation about a new court case to a group of attorneys, via a video conference. During the presentation, as well as after the presentation, several of the attorneys may be communicating with each other about how the new court case affects cases they are currently handling. They may refer to specific documents that may need to be updated in light of the court case. The law firm where the attorneys work could then make the conversation, including the recording of the video conference, copies of whatever materials were presented in the video conference, and copies of the documents that need to be updated, accessible in a single conversation on an intrafirm website available to all attorneys of the firm, regardless of whether they attended the video conference.

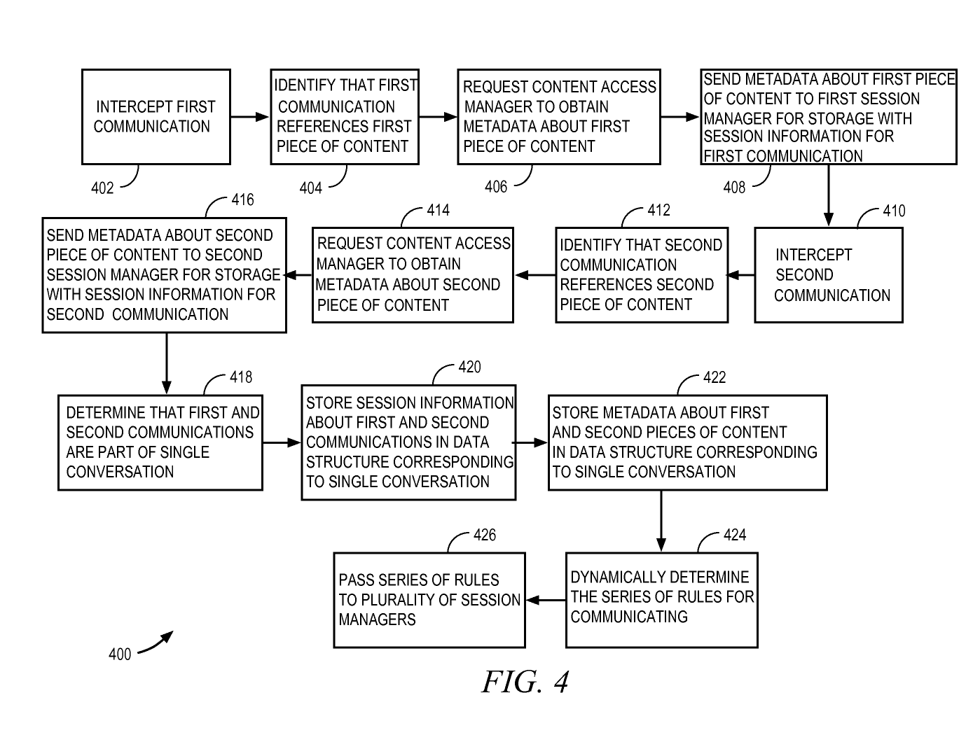

FIG. 4 is a flow diagram illustrating a method 400, in accordance with an example embodiment. At operation 402, a first communication having a destination of a first session manager can be intercepted. At operation 404, it may be identified that the first communication references a first piece of content. This may include performing machine learning techniques to identify portions of speech in the first communication referring to the first piece of content. At operation 406, a request may be sent to a content access monitor to obtain metadata about the first piece of content. At operation 408, the metadata about the first piece of content may be sent to the first session manager for storage with session information for the first communication.

At operation 410, a second communication having a destination of a second session manager can be intercepted. At operation 412, it may be identified that the second communication references a second piece of content. This may include performing machine learning techniques to identify portions of speech in the second communication referring to the second piece of content. At operation 414, a request may be sent to a content access monitor to obtain metadata about the second piece of content. At operation 416, the metadata about the second piece of content may be sent to the second session manager for storage with session information for the second communication.

At operation 418, it may be determined that the first communication and the second communication are part of a single conversation. This may include performing machine learning techniques to identify a correlation, such as a correlation in subject matter, time, or geography, between the first communication and the second communication. At operation 420, session information about the first communication and the second communication may be stored in a data structure corresponding to the single conversation. At operation 422, the metadata about the first piece of content and the metadata about the second piece of content may be stored in the data structure corresponding to the single conversation.

At operation 424, a series of rules to apply to communications may be dynamically determined. The rules may specify, for example, notifications to be sent to users when content related to conversations engaged in by the users is identified. At operation 426, the series of rules may be passed to the plurality of session managers.

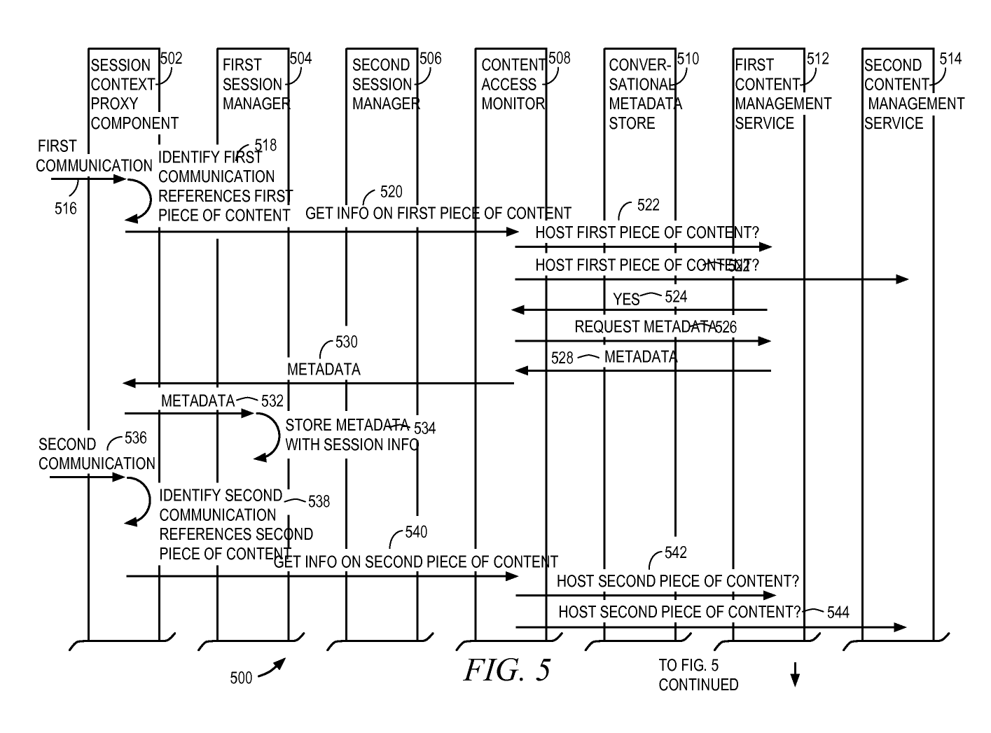

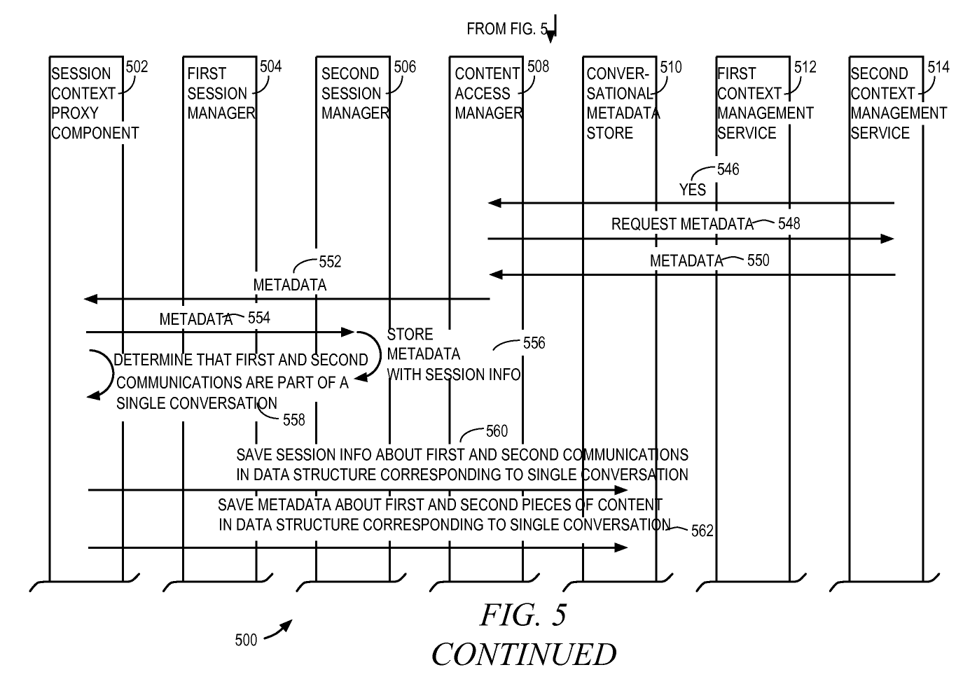

FIG. 5 is a sequence diagram illustrating a method 500 in accordance with an example embodiment. The method 500 may be performed using a session context proxy component 502, a first session manager 504, a second session manager 506, a content access monitor 508, a conversational metadata store 510, a first content management service 512, and a second content management service 514. At operation 516, a first communication is received at the session context proxy component 502. This first communication may be intended for the first session manager 504. At operation 518, the session context proxy component 502 may identify that the first communication references a first piece of content. At operation 520, the session context proxy component 502 may query the content access monitor 508 for information about the first piece of content. At operation 522, the content access monitor 508 may query a plurality of content management services, such as the first content management service 512 and the second content management service 514, to determine if one of them is hosting the first piece of content. At operation 524, the first content management service 512 may respond with an indication that it is hosting the first piece of content. At operation 526, the content access monitor 508 may request metadata for the first piece of content from the first content management service 512, which may respond with the metadata at operation 528. At operation 530, the content access monitor 508 may return the metadata to the session context proxy component 502, which at operation 532 may pass the metadata about the first piece of content to the first session manager 504. At operation 534, the first session manager 504 may store the metadata about the first piece of content with session information for the first communication.

At operation 536, a second communication is received at the session context proxy component 502. This second communication may be intended for the second session manager 506. At operation 538, the session context proxy component 502 may identify that the second communication references a second piece of content. At operation 540, the session context proxy component 502 may query the content access monitor 508 for information about the second piece of content. At operation 542, the content access monitor 508 may query a plurality of content management services, such as the first content management service 512 and the second content management service 514, to determine if one of them is hosting the first piece of content. At operation 546, the second content management service 514 may respond with an indication that it is hosting the second piece of content. At operation 548, the content access monitor 508 may request metadata for the second piece of content from the second content management service 514, which may respond with the metadata at operation 550. At operation 552, the content access monitor 508 may return the metadata to the session context proxy component 502, which at operation 554 may pass the metadata about the second piece of content to the second session manager 506. At operation 556, the second session manager 506 may store the metadata about the second piece of content with session information for the second communication.

At operation 558, the session context proxy component 502 may determine that the first communication and the second communication are part of a single conversation. At operation 560, session information about the first communication and the second communication, are stored in a data structure corresponding to the single conversation in the conversational metadata store 510. At operation 562, the metadata about the first and second pieces of content are stored in a data structure corresponding to the single conversation in the conversational metadata store 510.

### Example Mobile Device

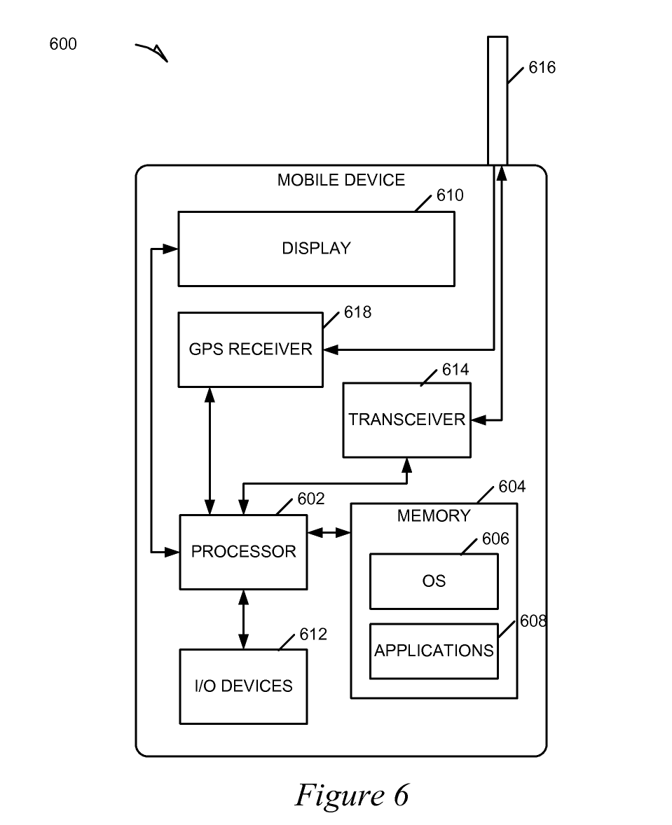

FIG. 6 is a block diagram illustrating a mobile device 600, according to an example embodiment. The mobile device 600 can include a processor 602. The processor 602 can be any of a variety of different types of commercially available processors suitable for mobile devices 600 (for example, an XScale architecture microprocessor, a Microprocessor without Interlocked Pipeline Stages (MIPS) architecture processor, or another type of processor). A memory 604, such as a random access memory (RAM), a Flash memory, or another type of memory, is typically accessible to the processor 602. The memory 604 can be adapted to store an operating system (OS) 606, as well as applications 608, such as a mobile location enabled application that can provide location based services (LBSs) to a user. The processor 602 can be coupled, either directly or via appropriate intermediary hardware, to a display 610 and to one or more input/output (I/O) devices 612, such as a keypad, a touch panel sensor, a microphone, and the like. Similarly, in some embodiments, the processor 602 can be coupled to a transceiver 614 that interfaces with an antenna 616. The transceiver 614 can be configured to both transmit and receive cellular network signals, wireless data signals, or other types of signals via the antenna 616, depending on the nature of the mobile device 600. Further, in some configurations, a GPS receiver 618 can also make use of the antenna 616 to receive GPS signals.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client, or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple such hardware-implemented modules exist contemporaneously, communications can be achieved through signal transmission (e.g., over appropriate circuits and buses that connect the hardware-implemented modules). In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one of processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment, or a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., application program interfaces (APIs)).

### Electronic Apparatus and System

Example embodiments can be implemented in digital electronic circuitry, in computer hardware, firmware, or software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of description language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

### Example Machine Architecture and Machine-Readable Medium

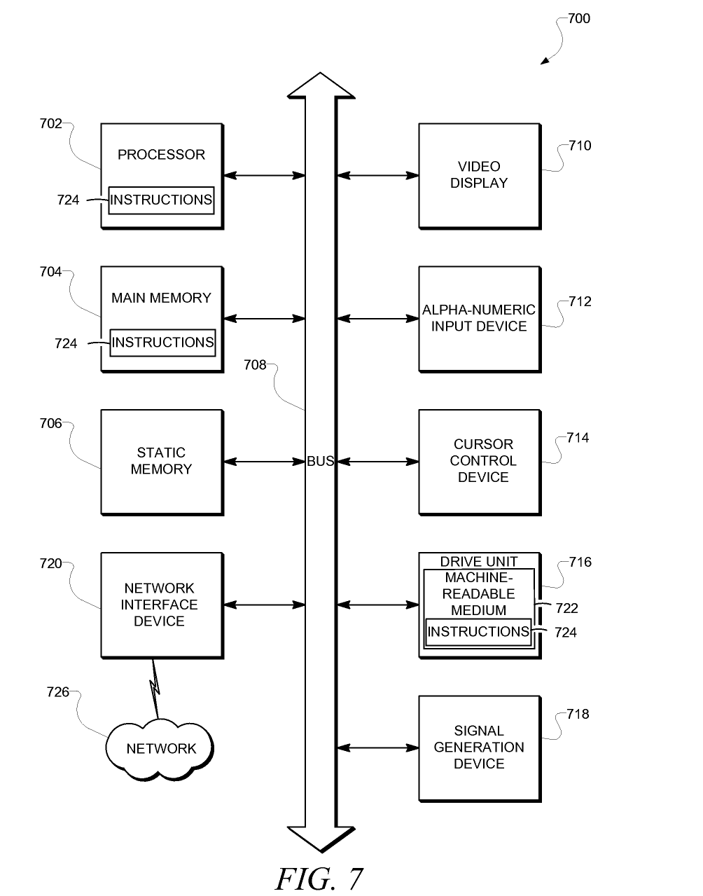

FIG. 7 is a block diagram of a machine in the example form of a computer system 700 within which instructions 724 may be executed to cause the machine to perform any one or more of the methodologies discussed herein. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 can further include a video display 710 (e.g., a liquid crystal display (LCD) or a cathode ray tube (CRT)). The computer system 700 also includes an alpha-numeric input device 712 (e.g., a keyboard or a touch-sensitive display screen), a user interface (UI) navigation (or cursor control) device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which are stored one or more sets of data structures and instructions 724 (e.g., software) embodying or utilized by any one or more of the methodologies or functions described herein. The instructions 724 can also reside, completely or at least partially, within the main memory 704 and/or within the processor 702 during execution thereof by the computer system 700, with the main memory 704 and the processor 702 also constituting machine-readable media 722.

While the machine-readable medium 722 is shown in an example embodiment to be a single medium, the term “machine-readable medium” can include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 724 can be transmitted or received over a communication network 726 using a transmission medium. The instructions 724 can be transmitted using the network interface device 720 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

This written description uses examples to disclose the inventive subject matter, including the best mode, and also to enable any person skilled in the art to practice the inventive subject matter, including making and using any devices or systems and performing any incorporated methods. The patentable scope of the inventive subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method comprising:
intercepting, at a session context proxy component, a first communication having a destination of a first session manager of a plurality of session managers, each session manager corresponding to a different communications modality;
identifying that the first communication references a first piece of content;
sending a request to a content access monitor to obtain metadata about the first piece of content;
sending the metadata about the first piece of content to the first session manager for storage with session information for the first communication;
intercepting, at the session context proxy component, a second communication having a destination of a second session manager of the plurality of session managers, the second communication in a different communications modality than the first communication;
identifying that the second communication references a second piece of content;
sending a request to the content access monitor to obtain metadata about the second piece of content; and
sending the metadata about the second piece of content to the second session manager for storage with session information for the second communication.

2. The method of claim 1, further comprising:
determining that the first communication and the second communication are a part of a single conversation;
storing the session information about the first communication and the second communication in a data structure corresponding to the single conversation; and
storing the metadata about the first piece of content and the metadata about the second piece of content in the data structure corresponding to the single conversation.

3. The method of claim 1, wherein the identifying that the first communication references a first piece of content includes performing machine learning techniques to identify portions of speech in the first communication referring to the first piece of content.

4. The method of claim 2, wherein the determining that the first communication and the second communication are part of a single conversation includes performing machine learning techniques to identify a correlation between the first communication and the second communication.

5. The method of claim 4, wherein the correlation pertains to subject matter of the first communication and the second communication.

6. The method of claim 4, wherein the correlation pertains to times of the first and second communications.

7. The method of claim 4, wherein the correlation pertains to geographic locations of users involved in the first and second communications.

8. The method of claim 2, wherein the determining that the first communication and the second communication are part of a single conversation includes locating a conversation identification stored in both the first and second communications.

9. The method of claim 1, further comprising:
dynamically determining a series of rules to apply to communications, the rules specifying notifications to be sent to users when content related to conversations engaged in by the users is identified; and
passing the series of rules to the plurality of session managers.

10. The method of claim 1, wherein the content access monitor obtains metadata about the first piece of content from a first content management system.

11. The method of claim 10, wherein the content access monitor further stores information about the first communication along with the first piece of content in the first content management system.

12. A system comprising:
a content access monitor comprising one or more processors; and
a session context proxy component comprising one or more processors configured to:
intercept, at the session context proxy component, a first communication having a destination of a first session manager of a plurality of session managers, each session manager corresponding to a different communications modality;
identify that the first communication references a first piece of content;
send a request to the content access monitor to obtain metadata about the first piece of content;
send the metadata about the first piece of content to the first session manager for storage with session information for the first communication;
intercept, at the session context proxy component, a second communication having a destination of a second session manager of the plurality of session managers, the second communication in a different communications modality than the first communication;
identify that the second communication references a second piece of content;
send a request to the content access monitor to obtain metadata about the second piece of content; and
send the metadata about the second piece of content to the second session manager for storage with session information for the second communication.

13. The system of claim 12, wherein the content access monitor is configured to obtain metadata about the first piece of content from a first content management system.

14. The system of claim 13, wherein the content access monitor is further configured to store information about the first communication along with the first piece of content in the first content management system.

15. The system of claim 12, wherein the system is contained in a conversation manager.

16. The system of claim 12, further comprising a learning component comprising one or more processors and configured to use machine learning techniques to identify references to pieces of content either explicitly or implicitly contained in communications.

17. A non-transitory machine-readable storage medium comprising instructions, which when implemented by one or more machines, cause the one or more machines to perform operations, the operations comprising:
intercepting, at a session context proxy component, a first communication having a destination of a first session manager of a plurality of session managers, each session manager corresponding to a different communications modality;
identifying that the first communication references a first piece of content;
sending a request to a content access monitor to obtain metadata about the first piece of content;
sending the metadata about the first piece of content to the first session manager for storage with session information for the first communication;
intercepting, at the session context proxy component, a second communication having a destination of a second session manager of the plurality of session managers, the second communication in a different communications modality than the first communication;
identifying that the second communication references a second piece of content;
sending a request to the content access monitor to obtain metadata about the second piece of content; and
sending the metadata about the second piece of content to the second session manager for storage with session information for the second communication.

18. The non-transitory machine-readable storage medium of claim 17, wherein the operations further comprise:
determining that the first communication and the second communication are a part of a single conversation;
storing the session information about the first communication and the second communication in a data structure corresponding to the single conversation; and
storing the metadata about the first piece of content and the metadata about the second piece of content in the data structure corresponding to the single conversation.

19. The non-transitory machine-readable storage medium of claim 17, wherein the identifying that the first communication references a first piece of content includes performing machine learning techniques to identify portions of speech in the first communication referring to the first piece of content.

20. The non-transitory machine-readable storage medium of claim 18, wherein the determining that the first communication and the second communication are part of a single conversation includes performing machine learning techniques to identify a correlation between the first communication and the second communication.
